(19) United States
(12) Patent Application Publication
(10) Pub. No.: US 2009/0154406 A1
(43) Pub. Date: Jun. 18, 2009

(54) DYNAMIC ADDRESS ALLOCATION METHOD FOR MOBILE AD HOC NETWORK

(75) Inventors: Haeyong Kim, Daejeon-city (KR); Sangcheol Kim, Daejeon-city (KR); Misun Yu, Daejeon-city (KR); Junkeun Song, Daejeon-city (KR); Pyeongsoo Mah, Daejeon-city (KR)

Correspondence Address: AMPACC LAW GROUP, 13024 Beverly Park Road, Suite 205, Mukilteo, WA, 98275, US

(73) Assignee: Electronics and Telecommunications Research Institute, Daejeon-city (KR)

(21) Appl. No.: 12/141,860

(22) Filed: Jun. 18, 2008

(30) Foreign Application Priority Data
Dec. 18, 2007 (KR) 10-2007-0133139

(51) Int. Cl. H04Q 7/00

(52) U.S. Cl. 370/329

(57) ABSTRACT

A dynamic address allocation method includes allowing a new terminal that desires to participate in the ad hoc network to broadcast an address block request message to neighbor terminals in order to be allocated with an address; allowing the new terminal to receive a plurality of address block reply messages from the neighbor terminals; allowing the new terminal to transmit an address block confirmation message to a 1-hop neighbor terminal in a normal state that has a largest address block on the basis of the plurality of address block reply messages; allowing the new terminal to receive an address block completion message, which includes bitmap information for an available address block, from the 1-hop neighbor terminal; and allowing the new terminal to be allocated with the address and to change its terminal state from an alone state to a normal state.

### BACKGROUND OF THE INVENTION

1. Field of the Invention

The present invention relates to a dynamic address allocation method for a mobile ad hoc network, and more particularly, to a dynamic address allocation method for a mobile ad hoc network that is capable of automatically allocating a unique address to a new terminal without overlapping a network address.

This work was supported by the IT R&D program of MIC/IITA [2006-S-085-01, Nano OS for Automobile Sensor Nodes].

2. Description of the Related Art

A mobile ad hoc network (MANET) means a group of mobile terminals that dynamically form a network without an infra structure. The mobile terminals can communicate with each other using a multi-hop technology even if a base station or a repeater, such as a wireless LAN access point (AP), is not installed. This field has been focused on a research on a routing protocol, and it is assumed that IP addresses are already allocated to terminals that participate in an ad hoc network.

In order for a new mobile terminal to communicate with the other mobile terminals that construct a mobile ad hoc network, the new mobile terminal needs to be allocated with an IP address before participating in the ad hoc network.

Examples of a method of allocating an IP address to a new mobile terminal include a static method that sets an IP address in advance, a dynamic IP address allocation method using a DHCP (Dynamic Host Configuration Protocol), a method of automatically allocating an IP address to a terminal using an LDAP (Local Distribution of Address Pool) algorithm, or the like.

As an example according to the related art, there is suggested an address allocation method using an IP site-local prefix pool in a mobile ad hoc network. The address allocation method includes allowing a plurality of terminals that participate in the mobile ad hoc network to generate link-local addresses and to perform a DAD so as to secure uniqueness of the link-local addresses; selecting a leader terminal notifying a site-local prefix of the mobile ad hoc network from the plurality of terminals; determining whether there is a neighbor network adjacent to the mobile ad hoc network; when it is determined that there is no neighbor network, allowing the leader terminal to randomly generate a site-local prefix pool including a plurality of site-local prefixes; selecting one site-local prefix from the site-local prefix pool and allocating the selected prefix as the site-local prefix of the mobile ad hoc network; and allowing the leader terminal to notify the allocated site-local prefix such that each of the plurality of terminals generates a site-local address. This method allocates non-overlapping site-local prefixes to two or more MANETs using a site-local prefix pool, thereby preventing the site-local addresses of the terminals from overlapping each other.

As another example according to the related art, there is suggested an ad hoc network constructing method using automatic IP address allocation. In the related art, IP addresses are automatically allocated to terminals using the DHCP. However, a current ad hoc network cannot use the DHCP that allows to automatically allocate an IP address because an infra structure does not exist due to its characteristics. Further, in the IP address automatic allocation method that is applied to the ad hoc network according to the related art, since the user intervention is required, it is inconvenient to the users who are not good at network setting.

As still another example according to the related art, a local distribution method of an address space in a mobile ad hoc network suggests an LDAP (Local Distribution of Address Pool) algorithm that makes it possible that a new terminal, which desires to participate in the ad hoc network, efficiently acquires an IP address without collision. In the LDAP algorithm, all terminals have an address pool for all IP addresses, and neighbor terminals distribute an address pool to a new terminal that desires to participate in the ad hoc network. The terminals that participate in the ad hoc network perform a series of operations according to a state of the ad hoc network and allocate addresses.

In algorithms for an address distribution in a mobile ad hoc network, it is generally assumed that an infra structure is connected to an existing network or each of the terminals has a unique ID at the time of being produced.

### SUMMARY OF THE INVENTION

Accordingly, the invention has been made to solve the above-described problems, and it is an object of the invention to provide a dynamic address allocation method for an ad hoc network that is capable of allocating a unique address, which does not overlap addresses of neighbor terminals on the ad hoc network, to a new terminal through only communication with the neighbor terminals without an infra structure or a unique ID.

According to an aspect of the invention, there is provided a dynamic address allocation method for an ad hoc network. The dynamic address allocation method includes allowing a new terminal that desires to participate in the ad hoc network to broadcast an address block request message to neighbor terminals in order to be allocated with an address; allowing the new terminal to receive a plurality of address block reply messages from the neighbor terminals; allowing the new terminal to transmit an address block confirmation message to a 1-hop neighbor terminal in a normal state that has a largest address block on the basis of the plurality of address block reply messages; allowing the new terminal to receive an address block completion message, which includes bitmap information for an available address block, from the 1-hop neighbor terminal; and allowing the new terminal to be allocated with the address and to change its terminal state from an alone state to a normal state.

According to anther aspect of the invention, there is provided a dynamic address allocation method for an ad hoc network. The dynamic address allocation method includes allowing a new terminal that desires to participate in the ad hoc network to broadcast an address block request message to neighbor terminals in order to be allocated with an address; when the new terminal receives no address block reply message from the neighbor terminals, allowing the new terminal to broadcast an address allocation request message to the neighbor terminals; when an available address exists in an address block that is used by a 1-hop neighbor terminal in a depleted state, allowing the 1-hop neighbor terminal to transmit an address allocation reply message including the available address to the new terminal; allowing the new terminal to transmit an address allocation confirmation message, which informs that the new terminal will use the corresponding address, to the 1-hop neighbor terminal; and allowing the new terminal to change its terminal state from an alone state to a depleted state.

According to still another aspect of the invention, there is provided a dynamic address allocation method for an ad hoc network. The dynamic address allocation method includes allowing a new terminal that desires to participate in the ad hoc network to broadcast an address block request message to neighbor terminals in order to be allocated with an address; when the new terminal receives no address block reply message from the neighbor terminals, allowing the new terminal to broadcast an address allocation request message to request for one address to the neighbor terminals; when the neighbor terminals are in a depleted state and have no available address, allowing a 1-hop neighbor terminal in a depleted state to broadcast an address allocation request message to the other neighbor terminals in a normal state to secure an address block, and to change its terminal state to a normal state; allowing the 1-hop neighbor terminal in a normal state to transmit an address block reply message to the new terminal; allowing the new terminal to transmit an address block confirmation message to the 1-hop neighbor terminal; allowing the 1-hop neighbor terminal to transmit an address block completion message including an available address block to the new terminal; and allowing the new terminal to be allocated with an address block and to change its terminal state from an alone state to a normal state.

As described above, according to the aspects of the invention, a new terminal can be allocated with a unique address that does not overlap addresses of neighbor terminals on an ad hoc network through only communication with the neighbor terminals without an infra structure or a unique ID, and a load generated in the entire ad hoc network can be minimized.

The methods according to the aspects of the invention can be applied to general cases in which an address is allocated to a new terminal using a dynamic address allocation protocol without a specific premise or assumption in the ad hoc network. All terminals that construct the ad hoc network operate at the same positions. Accordingly, as compared with cases where a specific terminal is selected and the other terminals operate according to a guiding principle of the specific terminal, it is possible to easily resolve problems occurring in the ad hoc network, which enables reliable communication.

### BRIEF DESCRIPTION OF THE DRAWINGS

FIG. 1 is a diagram illustrating the operation of a new terminal in the case where there is no neighbor terminal around the new terminal and the new terminal constructs a new ad hoc network;

FIG. 2 is a flowchart illustrating the operation of a method of allocating an address to a new terminal in the case where neighbor terminals in a normal state exist around the new terminal on an ad hoc network according to a first embodiment of the invention;

FIG. 3 is a flowchart illustrating the operation of a method of allocating an address to a new terminal in the case where neighbor terminals in a depleted state exist around the new terminal on an ad hoc network according to a second embodiment of the invention; and

FIG. 4 is a flowchart illustrating the operation of a method of allocating an address to a new terminal in the case where neighbor terminals in a depleted state and neighbor terminals in a normal state exist around the new terminal on an ad hoc network according to a third embodiment of the invention.

### DESCRIPTION OF THE PREFERRED EMBODIMENTS

Hereinafter, the preferred embodiments of the invention will be described with reference to the accompanying drawings.

Each of terminals that exist in an ad hoc network needs to store a bitmap (hereinafter, referred to as address pool) for a range of all available addresses so as to execute an algorithm suggested by the invention.

In the invention, an entire address pool is divided into blocks each of which has a predetermined size, and is managed. The size of each of the blocks needs to be optimally determined according to a frequency of terminals that participate in and leave from an ad hoc network, but can be changed. For example, when the terminals frequently participate in and leave from the ad hoc network, the size of each of the blocks is preferably large. In contrast, when the terminals rarely participate in and leave from the ad hoc network, the size of each of the blocks is preferably small.

The address pool that is divided into blocks is transmitted from the terminals, which have first constructed the ad hoc network, to a new node (hereinafter, referred to as new terminal). That is, when a new terminal requests for an address block in order to participate in the ad hoc network, neighbor nodes (hereinafter, referred to as neighbor terminals) that participate in the ad hoc network transmit an address block reply message to the new terminal in response to the address block request.

The new terminal receives one or more address block reply messages from the plurality of neighbor terminals. Then, the new terminal selects a neighbor terminal that has a largest address block and requests the selected neighbor terminal to allocate an address, and shares the address pool with the neighbor terminal that already participates in the ad hoc network.

In the ad hoc network, according to an alone state, a normal state, and a depleted state, each of the terminals operates as follows.

The alone state means a state where a new terminal 20 is not allocated with an address needed to perform communication. The new terminal 20 broadcasts an address block request message to all the neighbor terminals participating in the ad hoc network the first three times in order to be allocated with an address.

In this process, if the new terminal 20 receives address block reply messages from the neighbor terminals, the new terminal 20 selects a neighbor terminal 10a, which can provide a largest address block to the new terminal, through an address block confirmation message. If the new terminal 20 receives no address block replay message from the neighbor terminals, the new terminal 20 broadcasts an address allocation request message to all of the neighbor terminals on the ad hoc network.

The new terminal 20 transmits an address allocation confirmation message, which informs that the new terminal 20 will use a corresponding address, to a neighbor terminal selected from among the neighbor terminals to which the new terminal 20 transmits the address allocation request message, and participates in the ad hoc network.

In this process, if the new terminal 20 receives no address allocation completion message from the neighbor terminals, the new terminal 20 determines that a network is not formed around the new terminal, and constructs a new ad hoc network.

The normal state means a state where a corresponding terminal is allocated with an address and at least one address block other than an address block to which an address that the terminal uses belongs can be used.

The neighbor terminal 10a in a normal state receives an address block request message or an address allocation request message from the new terminal 20 that desires to participate in the ad hoc network, and transmits an address block reply message, which includes a size of an address block that neighbor terminal 10a can provide, to the new terminal 20. At this time, the size of the address block that the neighbor terminal 10a can provide to the new terminal 20 is half the entire address block that the neighbor terminal 10a has.

If the 1-hop neighbor terminal 10a in a normal state receives an address block confirmation message from the new terminal 20, the 1-hop neighbor terminal 10a transmits an address block completion message to the new terminal 20 in response to the received message and provides an address block having the predetermined size to the new terminal 20, and deletes the provided address block from its address block.

After receiving the address block completion message, the new terminal 20 changes its terminal state from an alone state to a normal state.

Then, after providing a part of its address block to the new terminal 20, the 1-hop neighbor terminal 10a in a normal state broadcasts an address block request message to the other neighbor terminals on the ad hoc network in order to compensate for the reduced address block, and additionally secure the address block in the same method as that used when the new terminal 20 is allocated with an address.

The depleted state means a state where a corresponding terminal is allocated with an address, and has only one address block that includes an address used by the terminal or has the address used by the terminal but does not have an address block. That is, the neighbor terminals in a depleted state cannot respond to the address block request message received from the new terminal 20.

However, if the 1-hop neighbor terminal that receives an address allocation request message to request for one address instead of an address block has an available address, the 1-hop neighbor terminal transmits an address allocation reply message to the new terminal to inform the new terminal of one available address.

If a 1-hop neighbor terminal 11a in a depleted state has no available address, the 1-hop neighbor terminal 11a broadcasts an address allocation request message to its neighbor terminals (2-hop neighbor terminals 11b) and confirms whether there is a neighbor terminal that can allocate an address to the new terminal 20 among neighbor terminals that is far away from the new terminal.

In this process, if the 1-hop neighbor terminal 11a in the depleted state receives address allocation reply messages from the 2-hop neighbor terminals 11b in the depleted state, the 1-hop neighbor terminal 11a forwards the received address allocation reply message to the new terminal 20.

If the 1-hop neighbor terminal 11a in the depleted state receives an address block reply message, the 1-hop neighbor terminal 11a possesses a corresponding address block through an address block confirmation message, and continuously performs a process of allocating an address to the new terminal 20 according to its terminal state.

If the new terminal 20 receives an address allocation reply message from the 1-hop neighbor terminal 11a in the depleted state, the new terminal 20 transmits an address allocation confirmation message to the 1-hop neighbor terminal 11a in a depleted state to inform that the new terminal will use a corresponding address. Then, the new terminal 20 changes its terminal state from an alone state to a depleted state.

As in the normal state, the 1-hop neighbor terminal 11a in the depleted state that has allocated an address to the new terminal 20 broadcasts an address block request message to the neighbor terminals (2-hop neighbor terminals in the depleted state), and confirms whether the 1-hop neighbor terminal can be allocated with an available address block from the neighbor terminals.

According to a dynamic address allocation algorithm in the ad hoc network that is suggested by the invention, each of the terminals maintains one of the three states described above. Without broadcasting an address block request message or an address allocation request message over the entire ad hoc network, each of the terminals generally performs communication with the 1-hop neighbor terminal 11a and can allocate an address, which does not overlap the addresses allocated to the other terminals on the ad hoc network, to the new terminal 20.

However, as in the invention, when no infra structure exists and a specific terminal does not manage the addresses in the entire ad hoc network by a centralized method, due to an abrupt leave or failure of the terminal, a network address may be lost and may not be used. In this invention, in order to resolve an address leak problem, the following method is used.

If a specific neighbor terminal that participates in the ad hoc network allocates an address to the new terminal 20 and has no available address except for its network address, the specific neighbor terminal becomes a network master. The specific neighbor terminal that has become the network master requests all of the terminals participating in the ad hoc network to transmit information for address blocks (including their addresses) used in the terminals. In this process, except for the address blocks that are being used by the other terminals, the other terminals delete all addresses that are not used. The network master possesses all of the address blocks that are not used by the other terminals. The address blocks that are possessed by the network master are distributed over the entire network upon an address allocation request from new terminals.

This process includes a routine that operates a monopoly-timer of the terminals that participate in the entire network, and the specific terminal cannot become the network master until the monopoly_timer is expired. This process is used to prohibit that a routine of searching an address leak is repeatedly executed.

When the new terminal 20 participates in the ad hoc network, this may be divided into the following three cases.

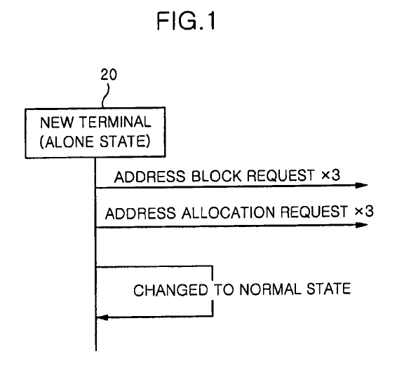

FIG. 1 is a diagram illustrating the operation of a new terminal in the case where neighbor terminals adjacent to the new terminal do not exist and the new terminal directly constructs a new ad hoc network.

In the ad hoc network, the new terminal 20 that is not allocated with an address broadcasts an address block request message to neighbor terminals that construct the ad hoc network, in order to be allocated with the address needed to perform communication. The address block request message is broadcast three times.

In this process, if the new terminal receives address block reply messages from the plurality of neighbor terminals, the new terminal 20 selects the neighbor terminal 10a that can provide a largest address block to the new terminal and transmits an address block confirmation message to the 1-hop neighbor terminal. After that, the new terminal 20 has the right to use the corresponding address block.

If the new terminal 20 receive no address block reply message from the neighbor terminals, the new terminal 20 broadcasts an address allocation request message to the neighbor terminals three times.

If the neighbor terminals receive an address allocation request message for one address needed to participate in the ad hoc network from the new terminal 20, the neighbor terminals transmit address allocation reply messages to the new terminal 20.

The new terminal 20 transmits an address allocation confirmation message, which informs that the new terminal will use the corresponding address, to the neighbor terminals that have transmitted the address allocation reply messages, and participates in the ad hoc network.

Even in this process, if the new terminal 20 receives no address allocation reply message, the new terminal 20 determines that the ad hoc network is not formed around the new terminal and constructs a new ad hoc network.

Then, as the new ad hoc network is constructed, the new terminal 20 possesses all blocks in a range of available addresses, and selects one address in one block to use the selected address as its address.

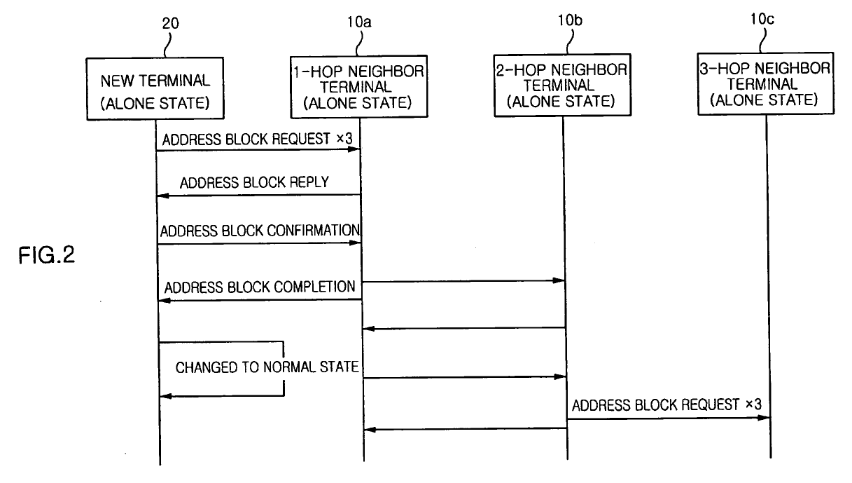

FIG. 2 is a flowchart illustrating the operation of a method of allocating an address to a new terminal in the case where neighbor terminals in a normal state exist around the new terminal in ad hoc network according to a second embodiment of the invention.

In order that the new terminal 20 in an alone state is allocated with an address to participate in the ad hoc network, the new terminal 20 broadcasts an address block request message to neighbor terminals the first three times.

The neighbor terminals in the normal state receive the address block request message broadcast from the new terminal 20 and transmit address block reply messages to the new terminal 20.

The new terminal 20 selects the 1-hop neighbor terminal 10a in a normal state that has the largest address block on the basis of the plurality of address block response messages received form the neighbor terminals. Then, the new terminal 20 transmits an address block confirmation message to the 1-hop neighbor terminal 10a in a normal state.

After receiving the address block confirmation message from the new terminal 20, the 1-hop neighbor terminal 10a in the normal state transmits an address block completion message, which includes bit map information for available address blocks among the entire network address pool, to the new terminal 20, and provides an address block having the predetermined size to the new terminal 20. Then, the 1-hop neighbor terminal 10a deletes the provided address block from its address block.

The new terminal 20 is allocated with an address, and changes its terminal state from an alone state to a normal state.

Then, the 1-hop neighbor terminal 10a in the normal state, which has provided the address block to the new terminal 20, broadcasts an address block request message to the other neighbor terminals on the ad hoc network the first three times in order to compensate for the reduced address block, and additionally secures an address block in the same method as that used when the new terminal is allocated with an address.

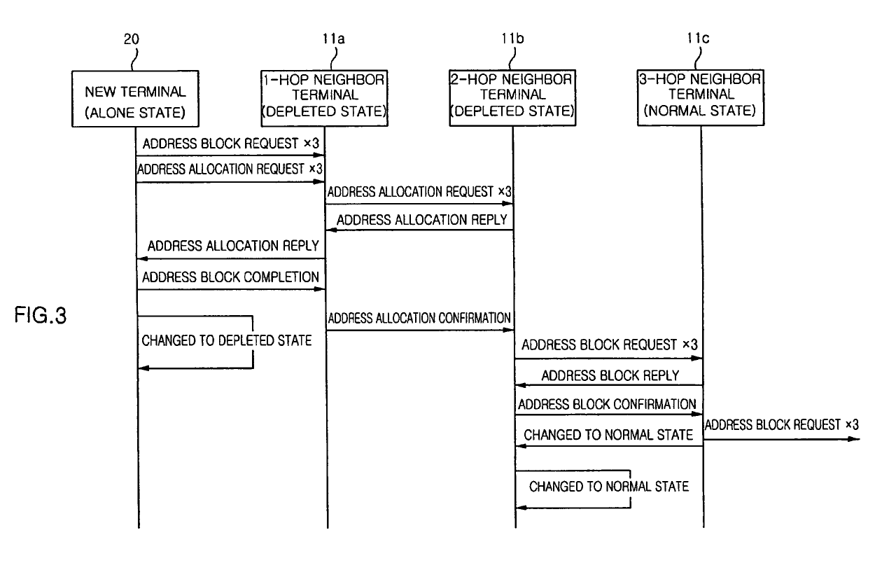

FIG. 3 is a flowchart illustrating the operation of a method of allocating an address to a new terminal in the case where neighbor terminals in a depleted state exist around the new terminal in an ad hoc network according to a second embodiment of the invention.

In order that the new terminal 20 in an alone state is allocated with an address to participate in the ad hoc network, the new terminal 20 broadcasts an address block request message to neighbor terminals the first three times.

In this case, if the 1-hop neighbor terminals 11a are in a depleted state, the 1-hop neighbor terminals 11a do not transmit address block reply messages to the new terminal.

If the new terminal 20 receives no address block reply message from the neighbor terminals, the new terminal 20 broadcasts an address allocation request message that requests for one address to the neighbor terminals three times.

If the 1-hop neighbor terminals 11a in a depleted state have available addresses in address blocks that are respectively used by the 1-hop neighbor terminals 11a, the 1-hop neighbor terminals 11a transmit address allocation reply messages including the available addresses to the new terminal 20.

The new terminal 20 selects the first received address allocation reply message, and transmits an address allocation confirmation message, which informs that the new terminal 20 will use the corresponding address, to the 1-hop neighbor terminals 11a in a depleted state.

Then, the new terminal 20 changes its terminal state from an alone state to a depleted state.

If all the neighbor terminals do not have available addresses, the 1-hop neighbor terminals 11a in a depleted state broadcast an address allocation request message to the 2-hop neighbor terminals that are further far away from the new terminal three times, and delegate responsibilities for address allocation to the 2-hop neighbor terminals.

When the 2-hop neighbor terminals 11b that have received the address allocation request messages are in a depleted state but have available addresses, the 2-hop neighbor terminals 11b transmit address allocation reply messages to the 1-hop neighbor terminals 11a in a depleted state.

Then, the 1-hop neighbor terminals 11a in a depleted state transmit address allocation reply messages to the new terminal 20. The new terminal 20 selects the first received address allocation reply message, and transmits an address allocation confirmation message, which informs that the new terminal 20 will use the corresponding address, to the 1-hop neighbor terminals 11a in a depleted state. The 1-hop neighbor terminals transmit the corresponding message to the 2-hop neighbor terminals 11b in a depleted state. In this way, an address allocation process is completed.

If the 2-hop neighbor terminals 11b are in a depleted state and do not have available addresses, the 2-hop neighbor terminals 11b transmit address block request messages to 3-hop neighbor terminals that are further far away from the new terminal, and delegate the responsibilities for address allocation to the 3-hop neighbor terminals.

The 2-hop neighbor terminals 11b in a depleted state broadcast an address block request message to the neighbor terminals three times, and receive address block reply messages from the 3-hop neighbor terminals 11c in a normal state.

The 2-hop neighbor terminals 11b in a depleted state select the 3-hop neighbor terminal 11c in a normal state having the largest address block on the basis of the plurality of address block reply messages that are received from the neighbor terminals. Then, the 2-hop neighbor terminals 11b transmit an address block confirmation message to the 3-hop neighbor terminals 11c in a normal state.

After receiving the address block confirmation message from the 2-hop neighbor terminals 11b in a depleted state, the 3-hop neighbor terminal 11c in a normal state transmits an address block completion message, which includes bitmap information for an available address block in the entire network address pool, to the 2-hop neighbor terminal 11b in a depleted state, and provides an address block having a predetermined size to the 2-hop neighbor terminal 11b. Then, the 3-hop neighbor terminal 11c deletes the provided address block from its address block.

The 2-hop neighbor terminal 11b in a depleted state secures a new address block, and changes its terminal state from a depleted state to a normal state.

Then, after providing the address block to the 2-hop neighbor terminal 11b in a depleted state, the 3-hop neighbor terminal 11c in a normal state broadcasts an address block request message to the other neighbor terminals on the ad hoc network the first three times, and additionally secures an address block in the same method as the above-described method.

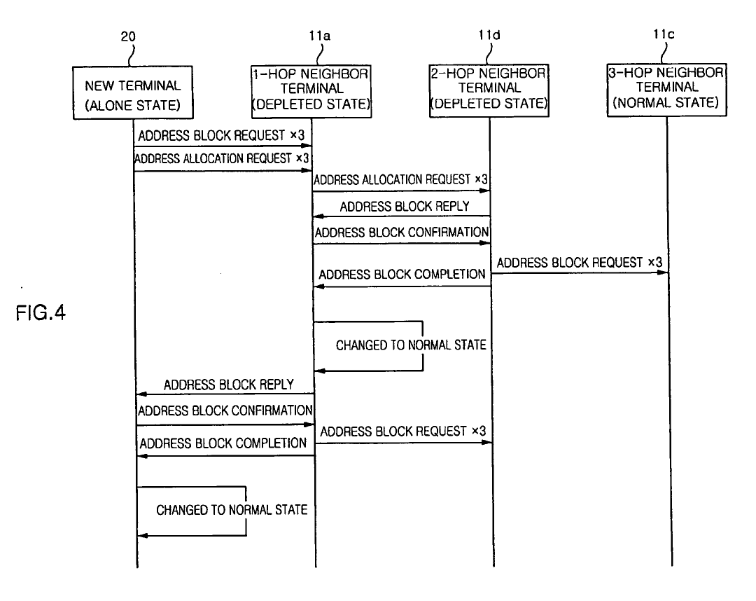

FIG. 4 is a flowchart illustrating the operation of a method of allocating an address to a new terminal in the case where neighbor terminals in a depleted state and neighbor terminals in a normal state exist around the new terminal in an ad hoc network according to a third embodiment of the invention.

The new terminal 20 in an alone state broadcasts an address block request message to neighbor terminals the first three times in order to be allocated with an address.

In this case, the 1-hop neighbor terminals 11a in a depleted state do not respond to an address block request message.

The new terminal 20 transmits an address allocation request message, which requests for one necessary address, to the 1-hop neighbor terminals 11a in a depleted state.

If the neighbor terminals are in a depleted state and do not have available addresses, the 1-hop neighbor terminals 11a in a depleted state broadcast an address allocation request message to the 2-hop neighbor terminals that are further far away from the new terminal three times, and delegates the responsibilities for address allocation to the 2-hop neighbor terminals.

When the 2-hop neighbor terminals 11d that have received the address allocation request message are in a normal state and have available address blocks, the 2-hop neighbor terminals transmit address block reply messages to the 1-hop neighbor terminals 11a in a depleted state.

The 1-hop neighbor terminals 11a in a depleted state select the 2-hop neighbor terminal 11d in a normal state that has the largest address block on the basis of the plurality of address block reply messages received from the neighbor terminals, and transmit address block confirmation messages, which inform that the 1-hop neighbor terminals 11a will use the corresponding address block, to the 2-hop neighbor terminals 11d in a normal state.

The 2-hop neighbor terminal 11d that has provided the address block deletes the provided address block from its address block. In order to compensate for the reduced address block, the 2-hop neighbor terminal 11d transmits an address block request message to the neighbor terminals three times, and transmits an address block completion message to the 1-hop neighbor terminals 11a in a depleted state.

Hereinafter, if the 1-hop neighbor terminals 11a in a depleted state receive the address block, the 1-hop neighbor terminals 11a change their terminal states from a depleted state to a normal state.

Since the 1-hop neighbor terminals 11a whose terminal states have been changed to a normal state have an address block that can provide to the new terminal 20, the 1-hop neighbor terminals 11a transmit an address block reply message to the new terminal 20.

The new terminal 20 receives the address block reply messages and transmits an address block confirmation message to the 1-hop neighbor terminals 11a in a normal state.

After receiving the address block confirmation message from the new terminal 20, the 1-hop neighbor terminals 11a in a normal state transmit an address block completion message, which includes bitmap information for an available address block in the entire network address pool, to the new terminal 20, and provide the address block having the predetermined size to the new terminal 20. Then, the 1-hop neighbor terminals 11a delete the provided address block from their address blocks.

The new terminal 20 is allocated with an address block and changes its terminal state from an alone state to a normal state.

A normal leave process of terminals that participate in an existing ad hoc network is as follows.

The terminals that desire to leave from the ad hoc network broadcast an address release message to the neighbor terminals. In response to the address release message, the neighbor terminals transmit the sizes of their address blocks to the terminals that desire to leave from the ad hoc network.

The terminals that desire to leave from the ad hoc network select the neighbor terminal having the smallest address block from among the neighbor terminals and transmit bitmap information for all address blocks possessed by the terminals to the selected terminal. The neighbor terminals that have received the bitmap information possess all of the corresponding address blocks. In this way, the network leave process of the terminals is completed.

Although the present invention has been described in connection with the preferred embodiments of the present invention, it will be apparent to those skilled in the art that various changes and modifications can be made without departing from the spirit and scope of the invention.

What is claimed is:

1. A dynamic address allocation method for an ad hoc network, the dynamic address allocation method comprising:
allowing a new terminal that desires to participate in the ad hoc network to broadcast an address block request message to neighbor terminals in order to be allocated with an address;
allowing the new terminal to transmit an address block confirmation message to a 1-hop neighbor terminal in a normal state that has a largest address block on the basis of the plurality of address block reply messages when the new terminal receives a plurality of address block reply messages from the neighbor terminals;
allowing the new terminal to receive an address block completion message, which includes bitmap information for an available address block, from the 1-hop neighbor terminal; and
allowing the new terminal to be allocated with the address and to change its terminal state from an alone state to a normal state.

2. The dynamic address allocation method of claim 1,
wherein, in the allowing of the new terminal to broadcast the address block request message, the new terminal broadcasts the address block request message to the neighbor terminals on the ad hoc network the first three times.

3. The dynamic address allocation method of claim 1,
further comprising, when the new terminal receives no address block reply message, allowing the new terminal to broadcast an address allocation request message to request for one address to the neighbor terminals, and to await address allocation reply messages transmitted from the neighbor terminals.

4. The dynamic address allocation method of claim 3,
wherein the new terminal broadcasts the address allocation request message to the neighbor terminals on the ad hoc network the first three times.

5. The dynamic address allocation method of claim 1,
further comprising, in the allowing of the new terminal to receive the address block completion message, allowing the 1-hop neighbor terminal in the normal state to transmit an address block completion message to the new terminal and to provide an address block having a predetermined size to the new terminal, and to delete the provided address block from its address block.

6. The dynamic address allocation method of claim 5,
further comprising allowing the 1-hop neighbor terminal in the normal state to broadcast an address block request message to the neighbor terminals on the ad hoc network the first three times in order to compensate for the reduced address block, and additionally to secure an address block.

7. The dynamic address allocation method of claim 1, further comprising:
allowing a terminal that desires to leave from the ad hoc network to broadcast an address release message to the neighbor terminals;
allowing the neighbor terminals to transmit the sizes of their address blocks to the terminal; and
allowing the terminal to select one of the neighbor terminals having a smallest address block and to transmit bitmap information for all address blocks of the terminal to the selected neighbor terminal.

8. A dynamic address allocation method for an ad hoc network, the dynamic address allocation method comprising:
allowing a new terminal that desires to participate in the ad hoc network to broadcast an address block request message to neighbor terminals in order to be allocated with an address;
when the new terminal receives no address block reply message from the neighbor terminals, allowing the new terminal to broadcast an address allocation request message to the neighbor terminals;
when an available address exists in an address block that is used by a 1-hop neighbor terminal in a depleted state, allowing the 1-hop neighbor terminal to transmit an address allocation reply message including the available address to the new terminal;
allowing the new terminal to transmit an address allocation confirmation message, which informs that the new terminal will use the corresponding address, to the 1-hop neighbor terminal; and
allowing the new terminal to change its terminal state from an alone state to a depleted state.

9. The dynamic address allocation method of claim 8,
wherein, in the allowing of the new terminal to broadcast the address block request message, the new terminal broadcasts the address block request message to the neighbor terminals on the ad hoc network the first three times.

10. The dynamic address allocation method of claim 8,
wherein, in the allowing of the new terminal to broadcast the address block request message, when the neighbor terminals are in a depleted state, the neighbor terminals do not transmit address block reply messages to the new terminal.

11. The dynamic address allocation method of claim 8,
wherein, in the allowing of the new terminal to transmit the address allocation request messages, the new terminal broadcasts the address allocation request message to the neighbor terminals on the ad hoc network the first three times.

12. The dynamic address allocation method of claim 8, further comprising, in the allowing of the 1-hop neighbor terminal to transmit the address allocation reply message when the 1-hop neighbor terminal in the depleted state does not have the available address:
allowing the 1-hop neighbor terminal to broadcast an address allocation request message to 2-hop neighbor terminals;
when the 2-hop neighbor terminals that have received the address allocation request message are in a depleted state but have available addresses, allowing the 2-hop neighbor terminals to transmit address allocation reply messages to the 1-hop neighbor terminal; and
allowing the 1-hop neighbor terminal to transmit an address allocation confirmation message, which informs that the 1-hop neighbor terminal will use a corresponding address, to the 2-hop neighbor terminal that is selected on the basis of the first received address allocation confirmation message.

13. The dynamic address allocation method of claim 12,
further comprising when the 2-hop neighbor terminals that have received the address allocation request message are in a normal state, allowing the 2-hop neighbor terminals to transmit address block reply messages to the 1-hop neighbor terminal.

14. The dynamic address allocation method of claim 12,
further comprising, in the allowing of the 2-hop neighbor terminals to transmit the address allocation reply messages:
when the 2-hop neighbor terminals are in a depleted state and have no available address, allowing the 2-hop neighbor terminals to transmit address block request messages to 3-hop neighbor terminals in a normal state;
allowing the 3-hop neighbor terminals to transmit a plurality of address block reply messages to the 2-hop neighbor terminals;
allowing the 2-hop neighbor terminals to transmit address block confirmation messages to the 3-hop neighbor terminal having a largest address block among the 3-hop neighbor terminals on the basis of the plurality of address reply messages received by the 2-hop neighbor terminals;
allowing the 3-hop neighbor terminal to transmit an address block completion message including bitmap information for an available address block to the 2-hop neighbor terminals and to delete the transmitted address block from its address block; and
allowing the 2-hop neighbor terminals to be allocated with addresses and to change their terminal states from a depleted state to a normal state.

15. A dynamic address allocation method for an ad hoc network, the dynamic address allocation method comprising:
allowing a new terminal that desires to participate in the ad hoc network to broadcast an address block request message to neighbor terminals in order to be allocated with an address;
when the new terminal receives no address block reply message from the neighbor terminals, allowing the new terminal to broadcast an address allocation request message to request for one address to the neighbor terminals;
when the neighbor terminals are in a depleted state and have no available address, allowing a 1-hop neighbor terminal in a depleted state to broadcast an address allocation request message to the other neighbor terminals in a normal state to secure an address block, and to change its terminal state to a normal state;
allowing the 1-hop neighbor terminal in a normal state to transmit an address block reply message to the new terminal;
allowing the new terminal to transmit an address block confirmation message to the 1-hop neighbor terminal;
allowing the 1-hop neighbor terminal to transmit an address block completion message including an available address block to the new terminal; and
allowing the new terminal to be allocated with an address block and to change its terminal state from an alone state to a normal state.

16. The dynamic address allocation method of claim 15,
wherein, in the allowing of the new terminal to broadcast the address block request message, the new terminal broadcasts the address block request message to the neighbor terminals on the ad hoc network the first three times.

17. The dynamic address allocation method of claim 15,
further comprising, in the allowing of the new terminal to broadcast the address block request message, when the new terminal receives no address block reply message from the neighbor terminals, allowing the new terminal to await address allocation reply messages transmitted from the neighbor terminals.

18. The dynamic address allocation method of claim 15,
wherein, in the allowing of the new terminal to broadcast the address allocation request message, the new terminal broadcasts the address allocation request message to the neighbor terminals the first three times.

19. The dynamic address allocation method of claim 15,
wherein, in the allowing of the 1-hop neighbor terminal to transmit the address block reply message, the 1-hop neighbor terminal in the normal state transmits an address block completion message to the new terminal and provides an address block having a predetermined size to the new terminal, and deletes the provided address block from its address block.

20. The dynamic address allocation method of claim 15, further comprising:
allowing a terminal that desires to leave from the ad hoc network to broadcast an address release message to the neighbor terminals;
allowing the neighbor terminals to transmit the sizes of their address blocks to the terminal; and
allowing the terminal to select one of the neighbor terminals having a smallest address block and transmit bitmap information for all address blocks of the terminal to the selected neighbor terminal.
